(19) United States
(12) Patent Application Publication
(10) Pub. No.: US 2007/0047544 A1
(43) Pub. Date: Mar. 1, 2007

(54) Method and system for conducting a group call

(76) Inventors: Craig T. Griffin, Chandler, AZ (US); Nandakishore A. Albal, Scottsdale, AZ (US); Robert D. Allen, Tempe, AZ (US)

Correspondence Address: MOTOROLA, INC., LAW DEPARTMENT, 1303 E. ALGONQUIN ROAD, SCHAUMBURG, IL, 60196, US

(21) Appl. No.: 11/211,286

(22) Filed: Aug. 25, 2005

(51) Int. Cl. H04L 12/56; H04J 3/16

(52) U.S. Cl. 370/390; 370/466; 370/401

(57) ABSTRACT

A method and system for conducting a group call between a source electronic device (116) and a plurality of destination electronic devices is disclosed. A packet characterized by a first coding technique and destined towards the plurality of destination electronic devices is received. The packet is processed to identify if at least one of the plurality destination electronic devices uses the first coding technique. The packet is then multiplied to form a plurality of packets. The plurality of packets is sent to the plurality of destination electronic devices using the first coding technique. Further, in case at least one of the plurality of destination devices uses a second coding technique, the packet is transcoded to the second coding technique. The transcoded packet is multiplied to form a plurality of transcoded packets. The plurality of transcoded packets are sent to the plurality of destination electronic devices using the second coding technique.

### BACKGROUND OF INVENTION

The present invention relates generally to the field of mobile communication. More specifically, the present invention describes a method for conducting a group call.

A group call is a way of creating a communication link between a plurality of electronic devices, so that each of the plurality of electronic devices can communicate simultaneously with each other. Examples of electronic devices include mobile phones, computers and the like. In existing networks, a source electronic device conducts a group call with a plurality of destination electronic devices, where the plurality of destination electronic devices may belong to different networks and use different coding techniques. Voice and data is exchanged between the networks in the form of packets. The coding technique for packets determines the compression of data to be sent in the form of packets and its quality when received by the plurality of destination electronic devices.

In accordance with a known method of conducting group calls, the source electronic device sends a packet to its domain network. The domain network is a service provider network that is responsible for providing the packet to each of the plurality of destination electronic devices. In case the domain network uses a coding technique that is different from the coding technique used in the network in which the source electronic device is in, the packet has to be transcoded from the coding technique used by the network in which the source electronic device is in to the coding technique used by the domain network. The domain network multiplies the packet to form a plurality of packets. The number of these packets is equal to the number of the destination electronic devices. The domain network then sends the plurality of packets to the plurality of destination electronic devices. Some of these destination electronic devices can be present in the network in which the source electronic device is, or in a network that uses the same coding technique as the network in which the source electronic device is. Packets destined to these destination electronic devices are retranscoded back to the coding technique use by the network in which the source electronic device is. This is known as double transcoding of the packets.

Further, all the packets destined for destination electronic devices in other networks also need to be transcoded individually. This leads to repetitive transcoding of the same packets, and is known as excessive transcoding.

One limitation of existing systems is that double transcoding leads to a loss in the quality of voice received at the destination electronic devices, as the quality reduces with each transcoding. Further, excessive transcoding increases costs of conducting group calls as transcoding is processor and hardware intensive.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates an environment where various embodiments of the present invention may be enabled, in accordance with an exemplary embodiment of the present invention;

FIG. 2 representatively illustrates a block diagram of a gateway, in accordance with an exemplary embodiment of the present invention;

FIG. 3 representatively illustrates a flow diagram for conducting a group call between networks, in accordance with an exemplary embodiment of the present invention;

FIG. 4 representatively illustrates a flow diagram for conducting a group call between networks, in accordance with yet another exemplary embodiment of the present invention;

FIG. 5 representatively illustrates a flow diagram for conducting a group call between networks, in accordance with still another exemplary embodiment of the present invention; and

FIG. 6 representatively illustrates a method for conducting a group call between networks, in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention.

Furthermore, the terms “first”, “second”, and the like herein, if any, are used inter alia for distinguishing between similar elements and not necessarily for describing a sequential or chronological order. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

Various representative implementations of the present invention may be applied to any system for conducting a group call between a source electronic device and a plurality of destination electronic devices. Though various embodiments of the invention are described with reference to a method of conducting a group call, however, the invention can as well be implemented in any other form of communication where problem of double transcoding and excessive transcoding are present.

The present invention describes a method for conducting a group call between a source electronic device and a plurality of destination electronic devices. The source electronic device and the plurality of destination electronic devices use at least two distinct coding techniques. In various embodiments of the invention, the network or networks can be wired or wireless. Examples of coding technique include, but are not limited to, Selection Mode Vocoder (SMV), Enhanced Variable Rate Coder (EVRC), Vector Sum Excited Linear Prediction (VSELP), Codebook Excited Linear Prediction (CELP), Linear Predictive Coding (LPC), Residual Pulse Excitation (RPE), Mixed Excitation Linear Prediction (MELP), Long Term Prediction (LTP), Multi Pulse Excited Linear Prediction (MPELP), Adaptive Multi-Rate (AMR) G.711, G.729/729A, and Advanced Multi-Band Excitation (AMBE++).

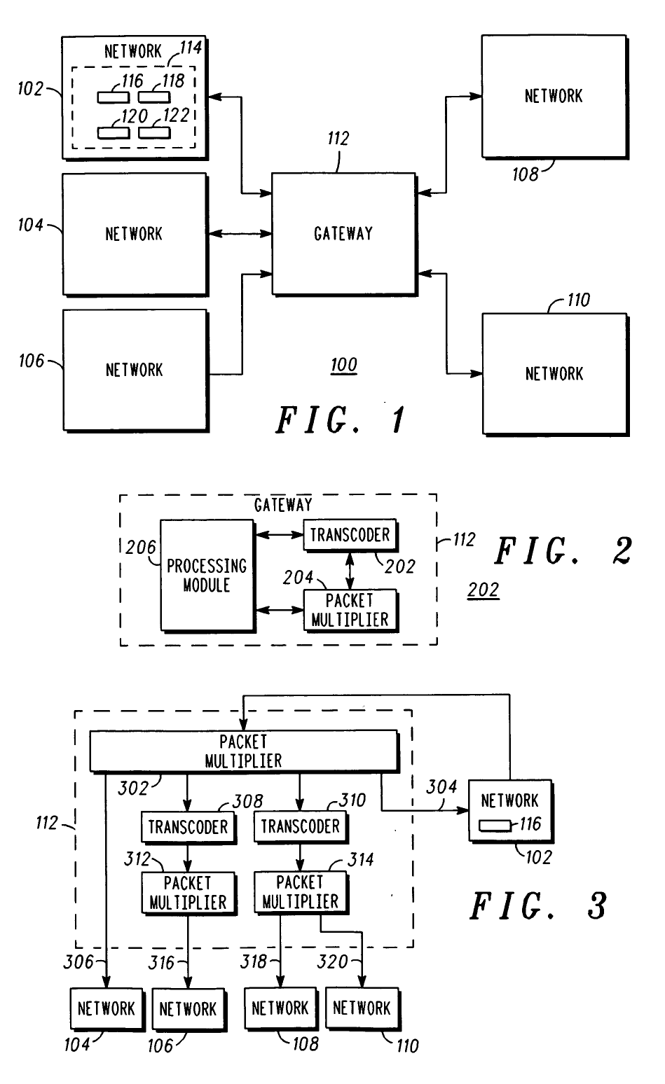

FIG. 1 representatively illustrates an environment 100 where various embodiments of the present invention may be practiced. The environment 100 may include one or more networks, for example and without limitation, network 102, a network 104, a network 106, a network 108, a network 110 and a gateway 112. All the communication between the networks 102, 104, 106, 108 and 110 is carried out through the gateway 112. Each of the networks includes a plurality of electronic devices. For example, as shown in FIG. 1, the network 102 includes a plurality of electronic devices 114. Further, the plurality of electronic devices 114 may include an electronic device 116, an electronic device 118, an electronic device 120 and an electronic device 122. In an embodiment, one or more electronic devices, regardless of whether they are in a single or distributed among multiple networks, may use one or more coding techniques and be within the scope of the invention. For example, electronic device 116 and 118 may use one coding technique while electronic devices 120 and 122 use another coding technique. In another embodiment, each network may use its own coding technique. In an embodiment, the method and apparatus described below is applicable to any two devices that use different coding techniques regardless of whether they are in the same network or region of a network. An exemplary embodiment is a source device and a destination device that each use different coding techniques.

FIG. 2 representatively illustrates a block diagram of the gateway 112. The gateway 112 includes a transcoder 202, a packet multiplier 204, and a processing module 206. The transcoder 202 transcodes packets from one coding technique to another technique, and vice versa, to form transcoded packets. The gateway 112 can have as many transcoders as required, depending on the different coding techniques used in the networks that the gateway 112 is connected to. In another embodiment, gateway 112 may have a dynamic transcoder capable of transcoding to/from a plurality of coding techniques as opposed to static transcoder configurations. The packet multiplier 204 multiplies a packet to form a plurality of packets. The transcoder 202 and the packet multiplier 204 can be coupled such the packet multiplier 204 multiplies that packets transcoded by the transcoder 202, or vice versa. The processing module 206 is responsible for controlling the transcoder 202 and the packet multiplier 204 and for guiding packets through gateway 212. The processing module 206 can instruct the transcoder 202 to receive a packet and transcode the packet to form a transcoded packet. The transcoded packet can then be sent to the packet multiplier 204 or to a destination electronic device depending on whether the packet needs to be multiplied or directly sent to a destination electronic device. The gateway 112 may include multiple instances of the transcoder 202 and the packet multiplier 204 for transcoding packets of various coding techniques and multiplying them. However, it should be appreciated that various embodiments of the present invention can also be practiced with the help of only one packet multiplier in the gateway 112. In this case, all packets that are to be multiplied are provided to one packet multiplier. These packets can be characterized by any coding technique. The time and resources required for packet multiplication are significantly less than that required for transcoding. Therefore, it is advantageous if only one packet is transcoded, and this packet is multiplied as many times as required, as compared to transcoding multiple packets. Similarly, the transcoding of packets can be performed by a single transcoder that has the capability to transcode packets from any first coding technique to any second technique.

Though various embodiments of the invention are described with the help of a gateway, it will be appreciated that the invention can also be implemented using distributed components that ensure that packets are not double transcoded while traveling between networks. In another embodiment of the invention, the packet multiplier 206 and the transcoder 202 are a part of the networks to which the source electronic device 116 and the plurality destination electronic devices are connected.

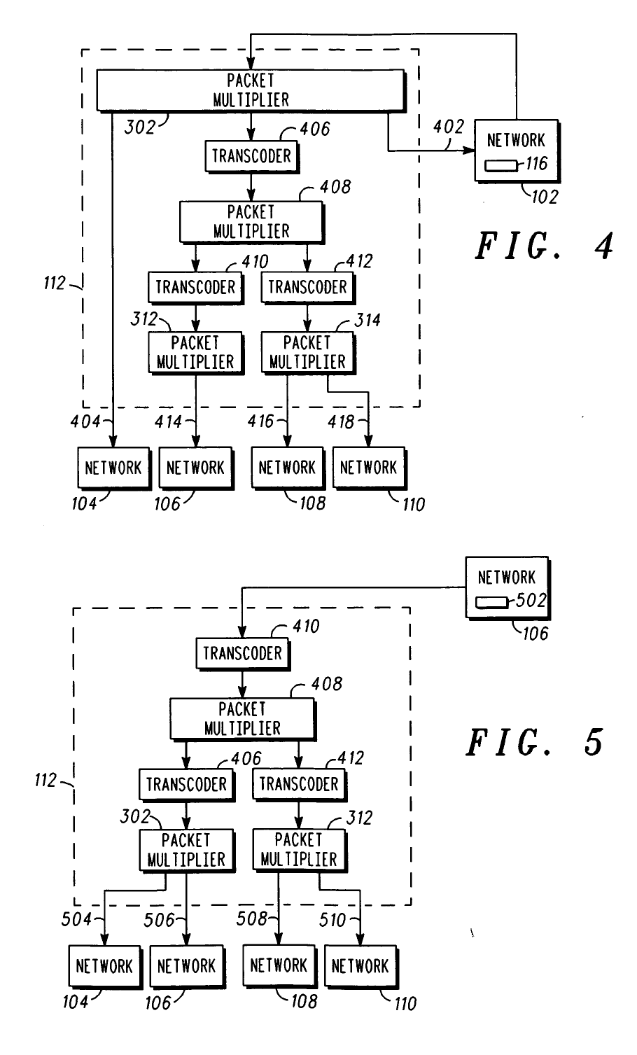

FIG. 3 representatively illustrates a flow diagram for conducting a group call between the network 102, the network 104, the network 106, the network 108 and the network 110, in accordance with an exemplary embodiment of the present invention. The networks 102 and 104 use a first coding technique, the network 106 uses a second coding technique, and the networks 108,110 use a third coding technique. The network 102 includes a source electronic device 116 establishing a group call with a plurality of destination electronic devices. The destination electronic devices are distributed in the networks 102, 104, 106, 108 and 110. At least one of the plurality of destination devices is in the network 102 itself. A source electronic device in a group call is an electronic device that wishes to send a packet to other electronic devices. Therefore, one of the destination electronic devices can become the source electronic device during the course of the group call. At any point of time, there may be many source electronic devices that send packets for many group calls that are simultaneously taking place. Further, the group call can be a half-duplex group call, or a full-duplex group call. In a half-duplex group call, only one electronic device can be a source electronic device at any instant in time. The source electronic device can change as electronic devices receiving packets during a group call can start sending packets, and hence become source electronic devices. In a full-duplex group call, any number of source electronic devices can exist at one time. This means that all the electronic devices can be sending packets to each other at one time. However, a packet received at the gateway 112 from any source electronic is handled as described in the various embodiments of the present invention. For the purpose of this description, various embodiments are described with particular source electronic devices, for example, the source electronic device 116.

Although the embodiment, depicted in FIG. 3 shows the source electronic device and the destination electronic device in different networks, this is not limiting of the invention. For example, the source electronic device and the destination electronic device may also be in the same network and be within the scope of the invention. In this embodiment, the functions of the gateway (transcoders and placket multiplier) may be either separate from the network as shown, or incorporated within the same network as the source and destination electronic devices.

During the setting up of the group call, the processing module 206 (not shown in FIG. 3) receives information regarding the source electronic device 116 and the plurality of destination electronic devices. This information may be provided to the processing module 206 with the help of signaling. Further, the processing module 206 identifies the coding techniques of the source electronic device 116 and the plurality of destination electronic devices. This information is used in guiding the packet through the gateway 112. During the group call, the source electronic device 116 sends a packet destined for the plurality of destination electronic devices to the gateway 112. The processing module 206 instructs the packet multiplier 302 to receive the packet and multiply the packet. The packet multiplier 302 generates packets 304 and 306 that are to be sent to the destination electronic devices belonging to the networks 102 and 104, respectively, as these packets need not be transcoded. In an embodiment of the invention, the number of the packets 304 and 306 is equal to the number of destination electronic devices belonging to the networks 102 and 104, respectively. In an embodiment of the invention, the packets 304 and 306 are sent through a plurality of parallel paths to the destination electronic devices belonging to the networks 102 and 104, respectively, i.e., though the packets are represented as single lines, each packet destined for each of the plurality of destination devices could be sent separately. However, in case the networks 102 and 104 may multiply the packets before sending them to the destination devices present in them, the packet multiplier 302 generates and sends only one packet for each of the networks 102 and 104. Since these packets do not need to be transcoded for a domain network, and then transcoded back, double transcoding is eliminated.

The packets destined for the plurality of destination electronic devices belonging to the networks 106, 108 and 110 that use different coding techniques, need to be transcoded before sending. The processing module 206 instructs the packet multiplier 302 to further generate packets that are provided to a transcoder 308 and a transcoder 310. One packet is generated for each unique coding technique used in the networks 106, 108 and 110. The transcoder 308 transcodes one packet from the first coding technique to the second coding technique. The transcoder 310 transcodes another packet from the first coding technique to the third coding technique. After transcoding, the transcoded packet is provided to a packet multiplier 312 that multiplies the packet to form packets 316. Similarly, a packet multiplier 314 multiplies a packet transcoded to the third coding technique to form packets 318 and 320. The processing module 206 instructs the packet multipliers 312 and 316 to send the packets 316, 318 and 320 to the plurality of destination electronic devices belonging to the networks 106, 108 and 110, respectively. Therefore, only one packet is transcoded for each coding technique, which is then multiplied and sent to destination electronic devices. This transcoding of a single packet solves the problem of excessive transcoding.

In an alternate embodiment of the invention, packet multipliers are implemented in the networks 102, 104, 106, 108 and 110, themselves. Therefore, a single transcoded packet is sent from the gateway 112 to the networks 102, 104, 106, 108 and 110 and multiplication of packets is performed by packet multipliers in to the networks. For example, in case the network 106 is capable of multiplying packets before sending them to the destination electronic devices in it, then there is no need for the packet multiplier 312. The transcoder 308 directly sends a transcoded packet to the network 106 which then multiplies the packet.

FIG. 4 representatively illustrates a flow diagram for conducting a group call between the network 102, the network 104, the network 106, the network 108 and the network 110, in accordance another exemplary embodiment of the present invention. The gateway 112 includes a transcoder 406 for transcoding a packet from the first coding technique to an intermediate or base coding technique, a transcoder 410 for transcoding a packet from the intermediate coding technique to the second coding technique and a transcoder 412 for transcoding a packet from the intermediate coding technique to the third coding technique. A combination of the transcoder 406 and the transcoder 410 or transcoder 412 is referred to as a tandem transcoder. Examples of the intermediate coding technique include, but are not limited to, Linear Pulse Code Modulation (LPCM), and Linear Speech Samples (LSS).

Although the embodiment, depicted in FIG. 4 shows the source electronic device and the destination electronic device in different networks, this is not limiting of the invention. For example, the source electronic device and the destination electronic device may also be in the same network and be. within the scope of the invention. In this embodiment, the functions of the gateway (transcoders and placket multiplier) may be either separate from the network as shown, or incorporated within the same network as the source and destination electronic devices.

A packet received from the source electronic device 116 is multiplied by packet multiplier 302. One of the multiplied packets is provided to transcoder 406, whereas, packets 402 and 404 are sent to the plurality of destination electronic devices belonging to the networks 102 and 104 respectively. The transcoder 406 transcodes the packet to form an intermediate transcoded packet. The intermediate transcoded packet is then sent to a packet multiplier 408 for multiplication. The packet multiplier 408 generates multiple intermediate transcoded packets that are provided to transcoders 410 and 412. The number of the intermediate transcoded packets generated by the packet multiplier 408 is equal to the number of unique coding techniques used by the networks in which the destination electronic devices are distributed. The transcoder 410 transcodes one intermediate transcoded packet from the intermediate coding technique to the second coding technique. After transcoding, the packet multiplier 312 multiplies the packet to generate packets 414. The transcoder 412 transcodes another intermediate transcoded packet from the intermediate coding technique to the third coding technique. After transcoding, a packet multiplier 314 multiplies the packet to generate packets 416 and 418. The packets 414, 416 and 418 are sent to the destination electronic devices belonging to the networks 106, 108 and 110, respectively. In an embodiment of the invention, the number of the packets 414, 416 and 418 is equal to the number of destination electronic devices in the networks 106, 108 and 110, respectively. In this way, this embodiment of the invention advantageously uses tandem transcoders for reducing the number of packets that need to be transcoded for the group call, when tandem transcoding is used.

FIG. 5 representatively illustrates a group call between the network 102, the network 104, the network 106, the network 108 and the network 110, in accordance with yet another exemplary embodiment of the present invention. A source electronic device 502 belongs to the network 106. This electronic device may be one of the plurality of destination devices described in conjunction with FIG. 3 and FIG. 4. The network 106 is the domain network of the source electronic device 502. A domain network provides the telecommunication services to all the electronic devices registered with it. The domain network also multiples packets destined to electronic devices that are connected to the domain network itself. Hence, there is no need of a packet multiplier for the destination electronic devices in the network 106.

Although the embodiment, depicted in FIG. 5 shows the source electronic device and the destination electronic device in different networks, this is not limiting of the invention. For example, the source electronic device and the destination electronic device may also be in the same network and be within the scope of the invention. In this embodiment, the functions of the gateway (transcoders and placket multiplier) may be either separate from the network as shown, or incorporated within the same network as the source and destination electronic devices.

The processing module 206 instructs the transcoder 410 to receive a packet from the source electronic device 502, transcode the packet to form an intermediate transcoded packet and send the intermediate transcoded packet to the packet multiplier 408 for multiplication. The transcoder 410 transcodes the packet from the second coding technique to the intermediate coding technique to form an intermediate transcoded packet. The packet multiplier 408 generates intermediate transcoded packets that are provided to the transcoders 406 and 412. The transcoder 406 transcodes one of the intermediate transcoded packets from the intermediate coding technique to the first coding technique to form a transcoded packet. The transcoder 412 transcodes another intermediate transcoded packet from the intermediate coding technique to the third coding technique to form another transcoded packet. The packet multipliers 302 and 312 multiply these transcoded packets to form packets 504, 506, 508 and 510. In an embodiment of the present invention, the number of packets 504, 506, 508 and 510 is equal to the number of destination electronic devices belonging to the networks 102, 104, 108 and 110, respectively. The processing module 206 instructs the packet multipliers 302 and 312 to send the packets 504, 506, 508 and 510 to the destination electronic devices belonging to the networks 102, 104, 108 and 110, respectively.

It should be appreciated that in various embodiment of the invention, as described in conjunction with FIG. 3, FIG. 4 and FIG. 5, the multiplication of packets performed by the packet multipliers can be performed by a single packet multiplier. In this case, the processing module 206 is responsible for guiding the packets that needs to be multiplied, to the single packet multiplier. Similarly, the transcoding of packets can be performed by a single transcoder that has the capability to transcode packets from any first coding technique to any second technique.

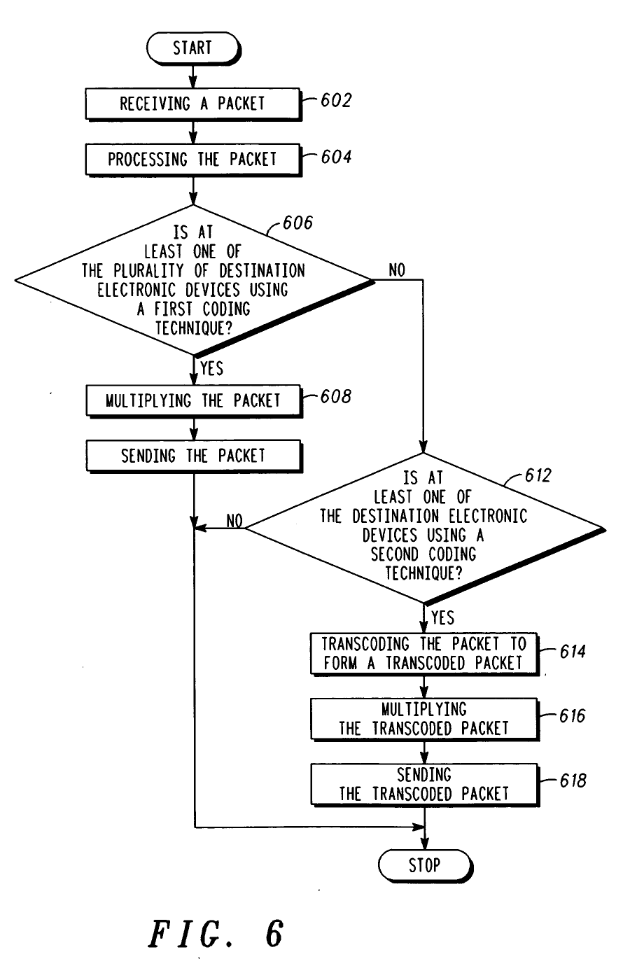

FIG. 6 representatively illustrates a method for conducting a group call, in accordance with an exemplary embodiment of the present invention. To conduct a group call, a source electronic device sends a packet destined towards a plurality of destination electronic devices. The source electronic device belongs to a network using a first coding technique. At step 602, the packet is received at a gateway. At step 604, the packet is processed at the gateway to identify the plurality of destination electronic devices. At step 606, it is determined whether the destination electronic devices belong to a network that uses the first coding technique. In case it is determined that at least one of the destination electronic devices uses the first coding technique, the packet is multiplied to form a plurality of packets at step 608. In an embodiment of the invention, the plurality of packets is equal to the number of destination electronic devices using the first coding technique. At step 610, the plurality of packets is sent to the plurality of destination electronic devices.

If the condition in step 606 is not satisfied, step 612 is performed. At step 612, it is determined whether at least one of the plurality of destination electronic devices uses a second coding technique. In case it is determined that at least one of the plurality of destination electronic devices uses the second coding technique, the packet is transcoded from the first coding technique to the second coding technique, at step 614, to form a transcoded packet. The transcoded packet is multiplied at step 616 to form a plurality of transcoded packets. At step 618, the plurality of transcoded packets are sent to the plurality of destination electronic devices. In an embodiment of the invention, the plurality of transcoded packets can be further transcoded. Further, the plurality of transcoded packets can also be multiplied.

Various embodiments of the present invention offer the following advantages. The present invention eliminates double transcoding and excessive transcoding from group calls. The present invention minimizes the number of transcodings required in conducting a group call. Various embodiments of the present invention reduce the number of transcodings required when tandem transcoding is used. Minimization of transcodings improves the voice quality in group calls. Another advantage of the present invention is that the number of transcodings in the group call does not increase with the number of electronic devices involved in conducting the group call. Various embodiments of the present invention can be used for any combination of group call aware and group call unaware networks. Further, in accordance with one embodiment of the invention, packet multipliers can also be implemented in the networks to which packets are destined, thereby reducing the number of packets passing through the gateway.

It will be appreciated the processing module, the packet multiplier and the transcoder described herein may be comprised of one or more conventional processors and unique stored program instructions that control the one or more processors to implement, in conjunction with certain non-processor circuits, some, most, or all of the functions of the modules described herein. The non-processor circuits may include, but are not limited to, a radio receiver, a radio transmitter, signal drivers, clock circuits, power source circuits, and user input devices. As such, these functions may be interpreted as steps of a method for conducting a group call. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes ” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A method for conducting a group call between a source electronic device and a plurality of destination electronic devices, the source electronic device and the plurality of destination electronic devices using at least two distinct coding techniques, the method comprising:
receiving a packet, wherein the packet is characterized by a first coding technique;
when at least one of the plurality of destination electronic devices uses the first coding technique:
multiplying the packet to form a plurality of packets; and
when at least one of the plurality of destination electronic devices uses a second coding technique:
transcoding the packet to the second coding technique to form a transcoded packet;
multiplying the transcoded packet to form a plurality of transcoded packets.

2. The method according to claim 1 further comprising identifying the coding techniques of the source electronic device and the plurality of destination electronic devices.

3. The method according to claim 1, wherein transcoding the packet comprises transcoding the packet from a first coding technique to an intermediate coding technique to form an intermediate transcoded packet.

4. The method according to claim 3, further comprising multiplying the intermediate transcoded packet to a plurality of intermediate transcoded packets.

5. The method according to claim 3, wherein transcoding the packet further comprises transcoding the packet from an intermediate coding technique to a second coding technique to form the transcoded packet.

6. A system suitable for conducting a group call between a source electronic device and a plurality of destination electronic devices, the source electronic device and the plurality of destination electronic devices using at least two distinct coding techniques, the system comprising:
at least one transcoder capable of transcoding a packet from a first coding technique to a second coding technique;
at least one packet multiplier capable of multiplying the packet to form a plurality of packets; and
a processing module capable of controlling the at least one transcoder and the at least one packet multiplier.

7. The system according to claim 6, wherein the source electronic device and the plurality of destination electronic devices belong to at least two distinct networks.

8. The system according to claim 6, wherein the source electronic device and the plurality of destination electronic devices are characterized by at least two distinct coding techniques.

9. The system according to claim 6, wherein each of the at least one packet multiplier is coupled to the at least one transcoder.

10. The system according to claim 6, wherein the processing module, the at least one transcoder and the at least one packet multiplier are part of a gateway.

11. The system according to claim 6, wherein the source electronic device and the plurality of destination electronic devices belong to a plurality of networks.

12. The system according to claim 11, wherein the at least one packet multiplier is implemented in the plurality of networks.

13. The system according to claim 6, wherein the first coding technique is selected from a group comprising Selection Mode Vocoder (SMV), Enhanced Variable Rate Coder (EVRC), Vector Sum Excited Linear Prediction (VSELP), Codebook Excited Linear Prediction (CELP), Linear Predictive Coding (LPC), Residual Pulse Excitation (RPE), Mixed Excitation Linear Prediction (MELP), Long Term Prediction (LTP), Multi Pulse Excited Linear Prediction (MPELP), Adaptive Multirate (AMR), G.711, G.729/729A, and Advanced Multi-Bit Excitation (AMBE++).

14. The system according to claim 6, wherein the second coding technique is selected from a group comprising Selection Mode Vocoder (SMV), Enhanced Variable Rate Coder (EVRC), Vector Sum Excited Linear Prediction (VSELP), Codebook Excited Linear Prediction (CELP), Linear Predictive Coding (LPC), Residual Pulse Excitation (RPE), Mixed Excitation Linear Prediction (MELP), Long Term Prediction (LTP), Multi Pulse Excited Linear Prediction (MPELP), Adaptive Multirate (AMR), G.711, G.729/729A, and Advanced Multi-Bit Excitation (AMBE++).
